(19) United States
(12) Patent Application Publication
(10) Pub. No.: US 2025/0293573 A1
(43) Pub. Date: Sep. 18, 2025

(54) ACTUATOR

(71) Applicant: FANUC CORPORATION, Yamanashi (JP)

(72) Inventor: Hidetoshi Uematsu, Yamanashi (JP)

(21) Appl. No.: 19/194,232

(22) Filed: Apr. 30, 2025

Related U.S. Application Data
(63) Continuation of application No. PCT/JP2023/004639, filed on Feb. 10, 2023.

(51) Int. Cl. H02K 11/21; H02K 7/116

(52) U.S. Cl. CPC H02K 11/21; H02K 7/116

(57) ABSTRACT

An actuator including a motor; a reduction gear; a primary encoder; and a secondary encoder. A rotary disk of the secondary encoder is disposed concentrically to a rotary disk of the primary encoder. The actuator comprises a first coupling part that couples an output shaft of the reduction gear and the rotary disk of the secondary encoder.

### CROSS-REFERENCE TO RELATED APPLICATIONS

This application is a bypass continuation application of International Application No. PCT/JP2023/004639 filed Feb. 10, 2023.

### BACKGROUND

### Field

The present disclosure relates to an actuator.

### Discussion of the Related Art

Actuators comprise a servo motor and a speed reducer which are connected to each other. A primary encoder is connected to the motor shaft of the servo motor for detecting the absolute position of the motor shaft within one rotation. Likewise, a secondary encoder is connected to the output shaft of the speed reducer for detecting the absolute position of the output shaft within one rotation. The total number of rotations of the primary encoder and/or the secondary encoder is detected (refer to, for example, Japanese Unexamined Patent Publication (Kokai) No. 2012-171072).

In recent actuators, the motor shaft of the motor is constructed as a hollow shaft, and the primary encoder is attached to the rear end thereof. The output shaft of the speed reducer extends toward the motor through the motor shaft, and the secondary encoder is attached to the rear end of the output shaft. Thus, the rotating disk of the secondary encoder is arranged concentrically with the rotating disk of the primary encoder.

In such a configuration, a relatively large space is required for affixing the rotating disk of the secondary encoder to the output shaft of the speed reducer.

Thus, an actuator which can save space is desired.

### SUMMARY

According to a first aspect of the present disclosure, there is provided an actuator, comprising a motor, a speed reducer which is connected to the motor, a primary encoder for detecting a position of a motor shaft of the motor, and a secondary encoder for detecting a position of an output shaft of the speed reducer, wherein a rotating disk of the secondary encoder is arranged concentrically relative to a rotating disk of the primary encoder, and the actuator further comprising a first joint for connecting the output shaft of the speed reducer and the rotating disk of the secondary encoder to each other.

The object, features, and advantages of the present disclosure will become more apparent from the description of embodiments below in association with the attached drawings.

### BRIEF DESCRIPTION OF DRAWINGS

FIG. 1A is an axial cross-sectional view of an actuator according to a first embodiment of the present disclosure.

FIG. 1B is a partial exploded view of the actuator of the first embodiment.

FIG. 1C is a view showing a modification example of the first embodiment.

FIG. 2A is an axial cross-sectional view of an actuator according to a second embodiment of the present disclosure.

FIG. 2B is a partial exploded view of the actuator of the second embodiment.

FIG. 2C is a view showing a modification example of the second embodiment.

FIG. 3A is an axial cross-sectional view of an actuator according to a third embodiment of the present disclosure.

FIG. 3B is a partial exploded view of the actuator of the third embodiment.

FIG. 4 is an axial cross-sectional view of an actuator according to another embodiment.

FIG. 5 is an axial cross-sectional view of an actuator of the prior art.

### DETAILED DESCRIPTION OF THE EMBODIMENTS

The embodiments of the present disclosure will be described below with reference to the attached drawings. In the drawings, corresponding constituent elements have been assigned common reference signs.

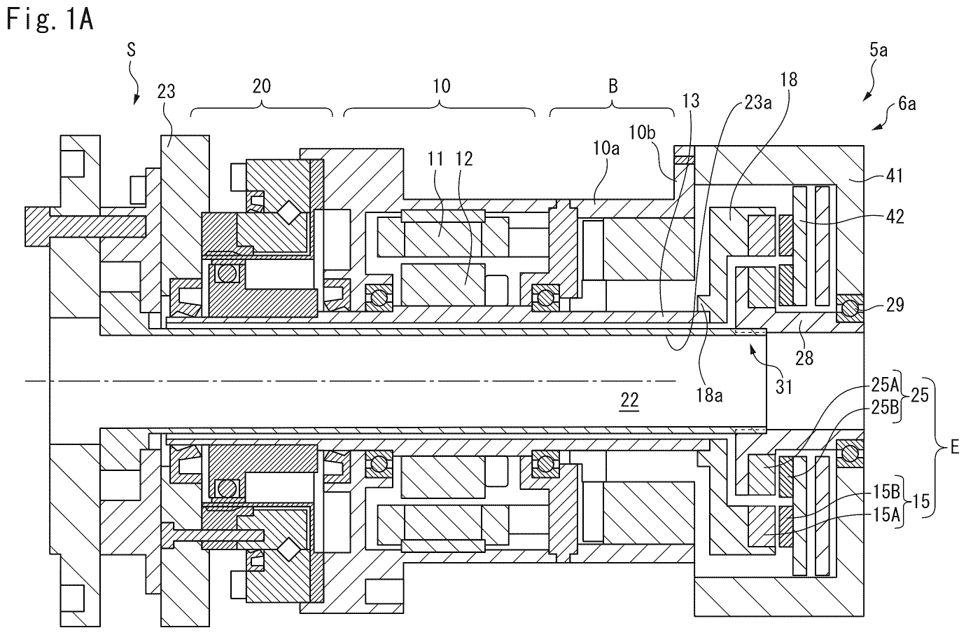

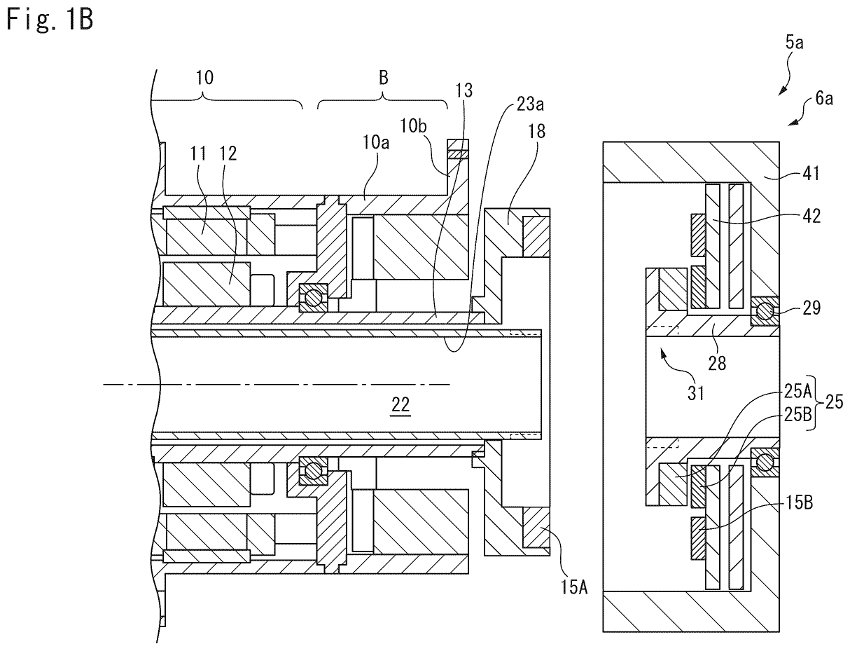

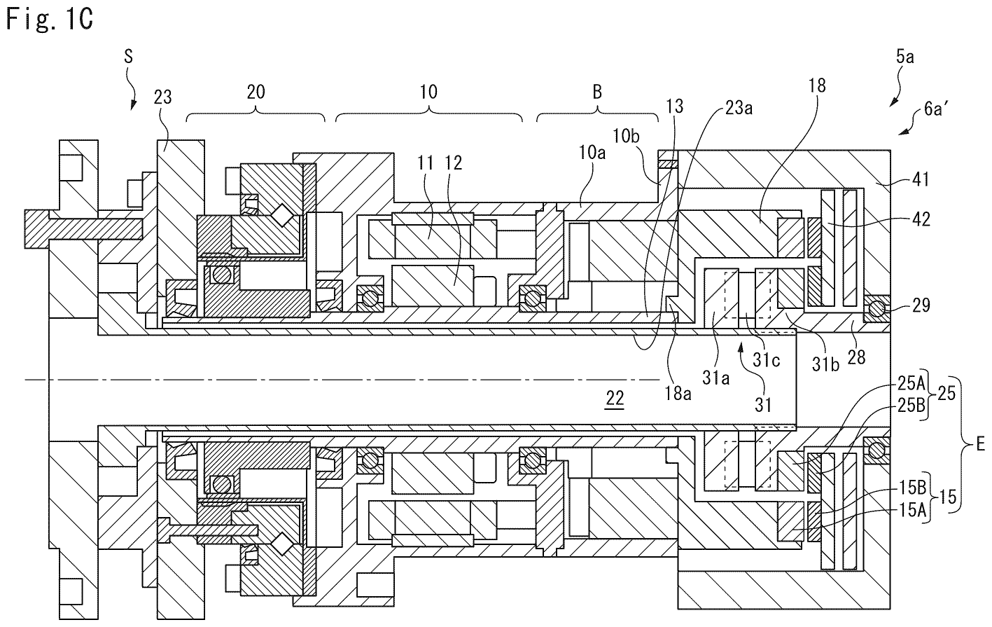

FIG. 1A is an axial cross-sectional view of an actuator based on a first embodiment of the present disclosure. The actuator 5a is incorporated in a machine having a shaft, such as a robot. Though the case in which the actuator 5a is incorporated in a robot will be described below, the same applies to the case in which the actuator 5a is incorporated in another machine having a shaft, such as a machine tool.

The actuator 5a primarily comprises a motor 10, for example, a servo motor, which is composed of a stator 11 and a rotor 12, an electromagnetic brake B which is connected to the motor 10, a speed reducer 20 which is connected to a motor shaft 13 of the motor 10, a force sensor S which is coupled to the speed reducer, and an encoder E.

The present disclosure specifies that the speed reducer 20 is arranged forward of the motor 10, and the motor 10 is arranged rearward of the speed reducer 20. In principle, the “radial direction” in the present disclosure means the radial direction of the actuator 5a, etc., and the “axial direction” means the axial direction of the actuator 5a, etc.

The motor 10 comprises the rotor 12 which rotates integrally with the motor shaft 13, and the stator 11 which is arranged so as to surround the rotor 12. The tip of an output shaft 23 of the speed reducer 20 is connected to a link 2 (not illustrated) via a force sensor S. Thus, the actuator 5 controls the positioning of the link 2 (not illustrated) by rotating the link 2 relative to the actuator 5 within a predetermined operating range. The reduction ratio of the speed reducer 20 is, for example, 1:50.

The motor shaft 13 is, for example, a hollow shaft, and the primary encoder 15 comprising a rotating disk 15A is attached to the rear end of the motor shaft 13. The primary encoder 15 is, for example, an absolute encoder, and outputs A-phase, B-phase, and Z-phase signals. The output signals are detected by a detector 15B for detecting the absolute position within one rotation of the motor shaft 13 and the total number of rotations of the motor shaft 13 by a known method. The detected information is stored in a memory of the detector 15B, for example, a volatile memory or a nonvolatile memory.

An extension 23a, for example, a hollow tube, is coupled to the output shaft 23 of the speed reducer 20, and this extension 23a passes through the hollow motor shaft 13 and extends toward the motor 10. A secondary encoder 25 comprising a rotating disk 25A is attached to the rear end of the extension 23a. The output shaft 23 of the speed reducer 20 and the extension 23a may be integrally formed. In other words, the extension 23a may be a part of the output shaft 23. Thus, hereinafter, the “extension 23a” may be expressed as the “output part 23.”

The secondary encoder 25 is, for example, an absolute encoder, and outputs A-phase, B-phase, and Z-phase signals. The output signals are detected by a detector 25B for detecting the absolute position within one rotation and total number of rotations of the output shaft 23 by a known method. The detected information is stored in a memory of the detector 25B, for example, a volatile memory or a non-volatile memory. The primary encoder 15 and the secondary encoder 25 may be collectively referred to as the encoder E.

The force sensor S is composed of a torque sensor for detecting the force acting around the axis of the actuator 5a. The force sensor S preferably has a spring part (not illustrated) which exhibits spring properties. When a force acts around the axis of the actuator 5a, since the spring part deforms, the force acting around the axis can be detected through the deformation amount of the spring part. The force sensor S may be a strain gauge, capacitive, magnetic, or an optical encoder.

As shown in the drawing, the force sensor S, the speed reducer 20, the motor 10, the electromagnetic brake B, and the encoder E, which are coaxially connected to each other, are preferably hollow structures. Furthermore, it is preferable that the hollow parts of the force sensor S, the speed reducer 20, the motor 10, the electromagnetic brake B, and the encoder E have a common inner diameter. As a result, the extension 23a, for example a hollow tube, can be arranged smoothly. Below, the internal spaces of the force sensor S, the speed reducer 20, the motor 10, the electromagnetic brake B, and the encoder E may be collectively referred to as the hollow part 22. Furthermore, at least one umbilical member (not illustrated), such as a signal line or a current supply line, is assumed to pass through the hollow part 22. Note that, as will be described later, the case in which the actuators 5a to 5c are configured so as to not include the force sensor S and/or the electromagnetic brake B is also included in the scope of the present disclosure. The same applies to other embodiments.

As shown in FIG. 1A, a circular first support member 18 extending in the radial direction is attached to the rear end of the motor shaft 13. An annular protrusion 18a is provided in the first support member 18, and it is preferable that the protrusion 18a engages with the rear end of the motor shaft 13. A radially outer portion of the first support member 18 extends in the axial direction of the motor shaft 13 so as to be separated from the motor 10. An annular rotating disk 15A for the primary encoder 15 is provided on the rear end surface of the above portion extending in the axial direction. In other words, the rotating disk 15A is supported by a portion of the first support member 18.

A flange 10b is provided at the rear end of a housing 10a of the actuator 5a. A cylindrical extension member 41 is attached to the flange 10b. The rear end surface of the extension member 41 extends inward in the radial direction. Furthermore, a second support member 28 is attached via a bearing 29 to the inner circumferential surface of the above portion extending inward in the radial direction. The inner diameter of the second support member 28 is approximately equal to the inner diameter of the hollow portion 22. A substrate 42 comprising the detectors 15B and 25B is attached to the inner circumferential surface of the extension member 41.

The second support member 28 extends from the rear end of the actuator 5a toward the speed reducer 20, and the tip of the portion extending toward the speed reducer 20 extends outward in the radial direction. An annular rotating disk 25A for the secondary encoder 25 is provided on the rear end surface of the portion extending outward in the radial direction. In other words, the rotating disk 25A is supported by a portion of the second support member 28.

Due to this configuration, the rotating disk 15A of the primary encoder 15 and the rotating disk 25A of the secondary encoder 25 are arranged concentrically with a predetermined gap therebetween. However, the rotating disk 15A and the rotating disk 25A may be arranged concentrically with each other in other configurations, and such configurations are within the scope of the present disclosure.

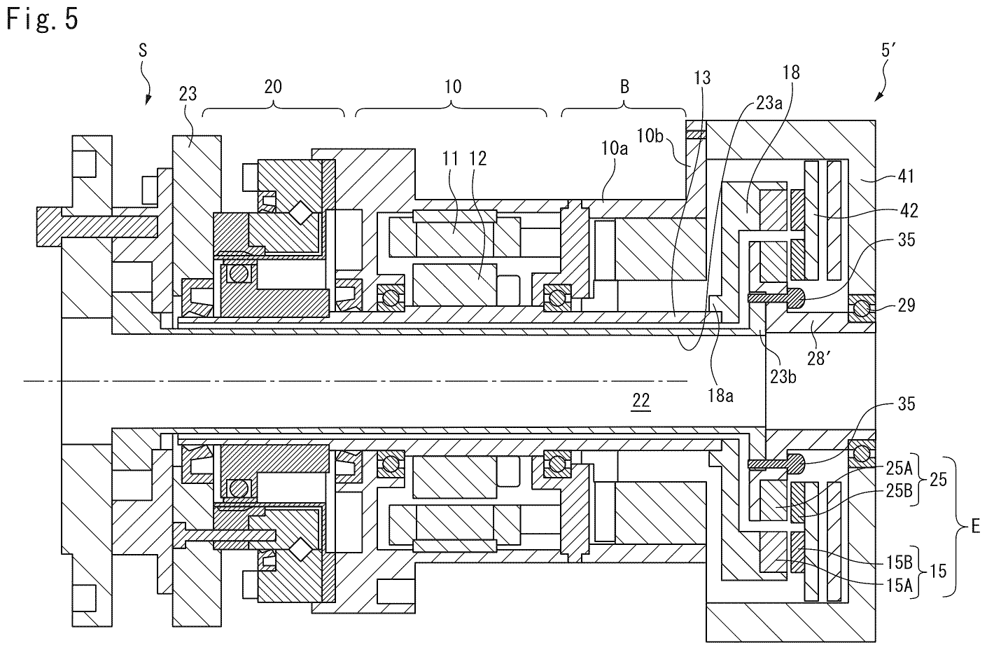

FIG. 5 is an axial cross-sectional view of an actuator 5′ of the prior art. In FIG. 5, a flange 23b extending outward in the radial direction is provided at the tip of the extension 23a. As can be understood from FIG. 5, a recess formed in a second support member 28′ engages with the flange 23b. Furthermore, a number of screws 35 parallel to the axial direction penetrate the second support member 28′ and the flange 23b to affix them to each other.

In such a configuration, in order to secure arrangement locations for the screws 35, it is necessary to move the rotating disk 25A and the rotating disk 15A outward in the radial direction by the size of the screws 35. In other words, the rotating disks 25A, 15A are enlarged by the size of the screws 35. Thus, a relatively large space is required for affixation of the rotating disk 25A of the secondary encoder 25 to the output shaft 23 of the speed reducer 20. As a result, in the prior art, there was a problem in that the actuator 5′ was made large.

In contrast thereto, in the first embodiment shown in FIG. 1A, the extension 23a (output shaft 23) of the speed reducer 20 and the rotating disk 25A are connected to each other by a first joint 31. Strictly speaking, the extension 23a of the speed reducer 20 and the second support member 28 for supporting the rotating disk 25A are connected to each other by the first joint 31. The second support member 28 may be interpreted as being a part of the first joint 31.

The first joint 31 serves to slide a portion 6a of the actuator 5a including the rotating disk 25A of the secondary encoder 25 in the axial direction of the actuator 5a so as to connect to the output shaft 23. Furthermore, the first joint 31 is configured not to allow the portion 6a of the actuator 5a to move in the circumferential and radial directions of the actuator 5a.

FIG. 1B is a partial exploded view of the actuator of the first embodiment. As shown in FIG. 1B, the unit 6a as a part of the actuator 5a includes the extension member 41, the bearing 29, the second support member 28, the substrate 42 having the detectors 15B, 25B, and the rotating disk 25A. The unit 6a is configured so as to be capable of operating as an integral unit.

When the unit 6a is slid toward the output shaft 23 in the axial direction of the actuator 5a, the second support member 28 of the unit 6a is connected to the output shaft 23 by the first joint 31. As a result, the unit 6a is prevented from moving in the circumferential direction and radial direction of the actuator 5a. The extension member 41 is affixed separately to the flange 10b of the housing 10a with screws or the like.

A typical first joint 31 is a combination of splines and grooves. Specifically, a plurality of splines are formed on one of the outer circumferential surface of the output shaft 23 and the inner circumferential surface of the second support member 28, and a plurality of grooves for engaging with the plurality of splines are formed on the other of the outer circumferential surface of the output shaft 23 and the inner circumferential surface of the second support member 28. The splines and grooves have predetermined lengths in the axial direction of the actuator 5a. Alternatively, the first joint 31 may be a combination of a key and a key groove which are formed so as to extend in the axial direction of the actuator 5a.

FIG. 1C is a view showing a modification example of the first embodiment. The first joint 31 of FIG. 1C includes an Oldham coupling. In this case, a first hub 31a is provided on the circumferential surface of the output shaft 23, and a second hub 31b is formed on the end surface of the second support member 28 so as to face the first hub 31a. Grooves perpendicular to each other are formed in advance in the first hub 31a and the second hub 31b. The grooves extend at least partially in the diametrical direction of the actuator 5a. Furthermore, the first hub 31a and the second hub 31b have a hollow portion extending in the axial direction of the actuator 5a.

Furthermore, an annular insert 31c having a hollow portion is arranged between the first hub 31a and the second hub 31b and engages with the first hub 31a and the second hub 31b. One surface of the insert 31c is provided with a protrusion which extends at least partially in the diametrical direction of the actuator 5a, and the other surface of the insert 31c is provided with a protrusion which extends in a direction perpendicular to the protrusion.

Since the second support member 28 of the unit 6a is connected to the output shaft 23 in the same manner as described above by utilizing an Oldham coupling comprising the first hub 31a, the second hub 31b and the insert 31c, the unit 6a does not move in the circumferential and radial directions of the actuator 5a.

The first joint 31 may also have a configuration including the splines described above. Furthermore, the first joint 31 may have another configuration in which the portion 6a of the actuator 5a including the rotating disk 25A of the secondary encoder 25 is slide in the axial direction of the actuator 5a so as to connect to the output shaft 23.

When using such a first joint 31 (splines or Oldham coupling), there is no need to insert the screws 35, and thus, there is no need to increase the size of the first support member 18 and the second support member 28 in the radial direction. Therefore, the rotating disks 25A, 15A can be arranged more inward in the radial direction than in the prior art. Furthermore, it is also possible to eliminate the flange 23b from the output shaft 23. Thus, the first embodiment can provide an actuator that enables space saving.

As described above, in the prior art shown in FIG. 5, the second support member 28′ is affixed to the flange 23b of the output shaft 23 using the screws 35. In the configuration shown in FIG. 5, it is necessary to affix the second support member 28′ to the flange 23b using the screws 35 after considering the total tolerance when assembling the force sensor S, the speed reducer 20, the motor 10, and the electromagnetic brake B. In this case, it is necessary to further consider the gap between the rotating disk 25A supported by the second support member 28′ and the detector 25B arranged on the substrate 42, and the gap between the rotating disk 15A supported by the first support member 18 and the detector 15B arranged on the substrate 42. Since such a positioning operation is relatively complicated, it was difficult to create a high-precision actuator 5′ in the prior art.

In contrast, in the first embodiment, the rotating disk 25A is included in the unit 6a, and the position of the rotating disk 25A in the unit 6a is uniquely determined. Since the unit 6a is simply slid in the axial direction so as to be connected to the output shaft 23 by the first joint 31 in the first embodiment, the rotating disk 25A can easily be arranged in an appropriate position. Thus, the gap management after the unit 6a is assembled described above can be performed with high accuracy. As a result, a high-accuracy actuator 5a can be provided. It will be understood that for the same reasons, the unit 6a can be easily removed from the actuator 5a when the first joint 31 is used.

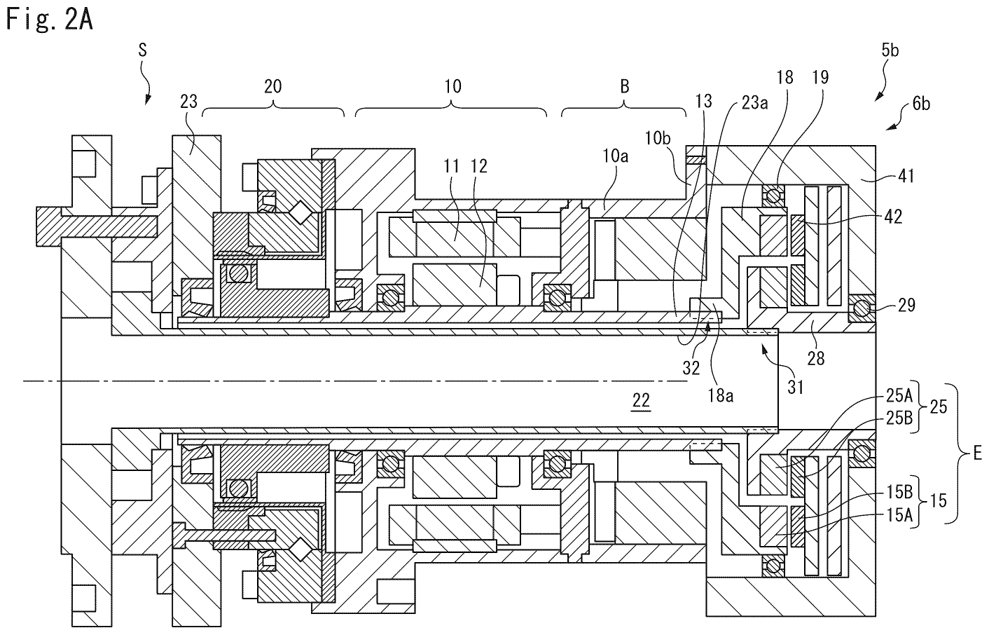

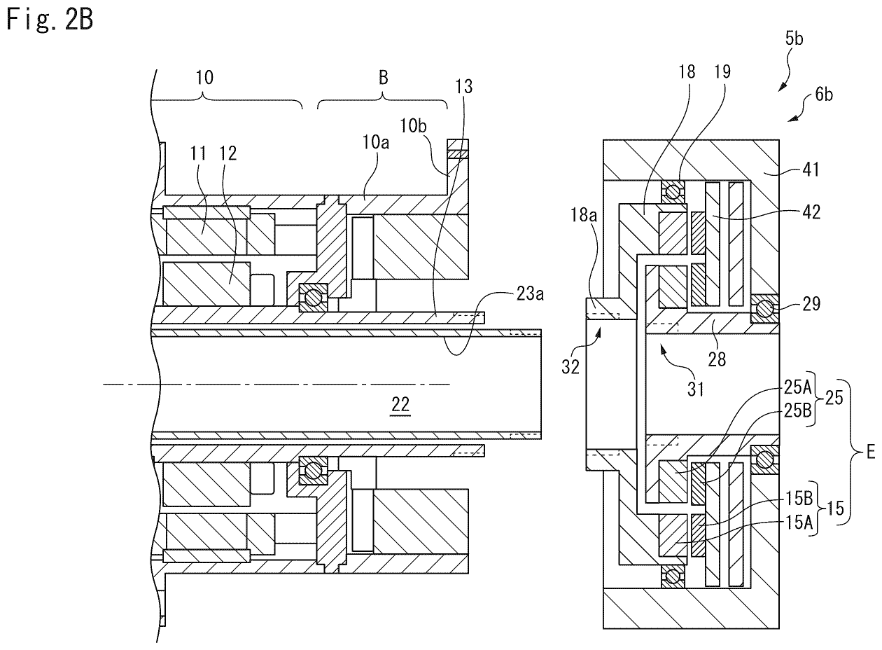

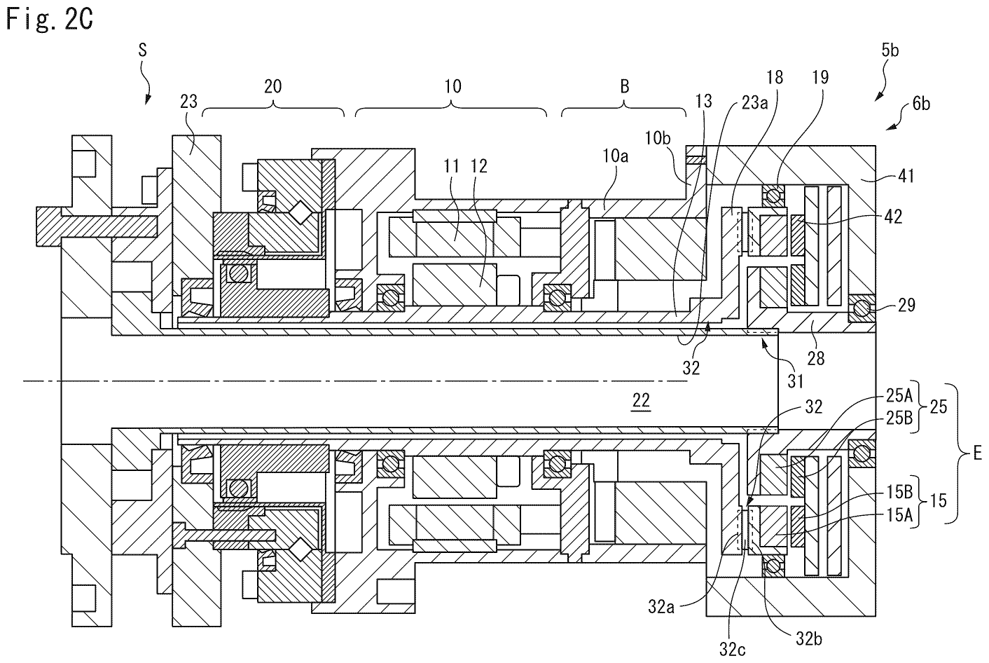

FIG. 2A is an axial cross-sectional view of an actuator according to a second embodiment of the present disclosure. The difference between the first embodiment shown in FIG. 1A and the second embodiment shown in FIG. 2A is that a bearing 19 is arranged between the first support member 18 and the extension member 41, and a second joint 32 connects the protrusion 18a of the first support member 18 and the motor shaft 13 to each other. Note that the first support member 18 may be interpreted as a part of the second joint 32.

The second joint 32 serves to slide the portion 6b of the actuator 5b including the rotating disks 25A, 15A in the axial direction of the actuator 5b so as to connect to the motor shaft 13. Furthermore, the second joint 32 is configured to not allow the portion 6b of the actuator 5b to move in the circumferential and radial directions of the actuator 5b.

FIG. 2B is a partial exploded view of the actuator of the second embodiment. As shown in FIG. 2B, the unit 6b as a part of the actuator 5b includes the extension member 41, the bearing 29, the second support member 28, the substrate 42 including the detector 15B and the detector 25B, the rotating disk 25A, the first support member 18, the rotating disk 15A, and the bearing 19. The unit 6b is configured so as to be capable of operating as an integral unit.

When the unit 6b is slid toward the output shaft 23 and the motor shaft 13 in the axial direction of the actuator 5b, the second support member 28 of the unit 6b is connected to the output shaft 23 by the first joint 31, and the first support member 18 of the unit 6b is connected to the motor shaft 13 by the second joint 32. As a result, the unit 6b is prevented from moving in the circumferential and radial directions of the actuator 5b. The extension member 41 is separately affixed to the flange 10b of the housing 10a with screws or the like.

A typical second joint 32 is a combination of splines and grooves. Specifically, a plurality of splines are formed on one of the outer circumferential surface of the motor shaft 13 and the inner circumferential surface of the protrusion 18a of the first support member 18, and a plurality of grooves for engaging with the plurality of splines are formed on the other of the outer circumferential surface of the motor shaft 13 and the inner circumferential surface of the protrusion 18a of the first support member 18. The splines and grooves have predetermined lengths in the axial direction of the actuator 5a.

Alternatively, the second joint 32 may be a combination of a key and a keyway formed so as to extend in the axial direction of the actuator 5a. To this end, the projection 18a of the first support member 18 preferably has a predetermined length in the axial direction of the actuator 5b. Furthermore, the second joint 32 may comprise an Oldham coupling having a configuration similar to that shown in FIG. 1C.

FIG. 2C is a view showing a modification example of the second embodiment. The second joint 32 of FIG. 2C comprises an Oldham coupling. In this case, the first support member 18 is divided into a motor side portion and an encoder side portion including the rotating disk 15A. The motor side portion may be integral with the motor shaft 13. A first hub 32a is provided on the end surface of the motor side portion, and a second hub 32b is formed on the end surface of the encoder side portion so as to face the first hub 32a. Grooves which are perpendicular to each other are formed in the first hub 32a and the second hub 32b in advance. The grooves extend at least partially in the diametric direction of the actuator 5b. The first hub 32a and the second hub 32b are each provided with a hollow portion that extends in the axial direction of the actuator 5a. Furthermore, an annular insert 32c having a hollow portion is arranged between the first hub 32a and the second hub 32b, and engages with the first hub 32a and the second hub 32b. A protrusion which extends at least partially in the diametrical direction of the actuator 5a is provided on one surface of the insert 32c, and a protrusion which extends in a direction perpendicular to the protrusion is provided on the other surface of the insert 32c.

In such a case, an actuator which enables space saving in the same manner as described above can be provided.

Furthermore, in the second embodiment, the rotating disks 15A, 25A are included in the unit 6b, and the positions of the rotating disks 15A, 25A in the unit 6b are uniquely determined. Since the unit 6b is simply slid in the axial direction to be connected to the output shaft 23 by the first joint 31 and to the motor shaft 13 by the second joint 32 in the second embodiment, the rotating disks 15A, 25A can be easily arranged in the appropriate positions. Thus, the gap management after the unit 6b is assembled described above can be performed with even higher accuracy. As a result, an actuator 5b with even higher accuracy can be provided. It will be understood that for the same reasons, the unit 6b can be easily removed from the actuator 5b when the first joint 31 and the second joint 32 are used.

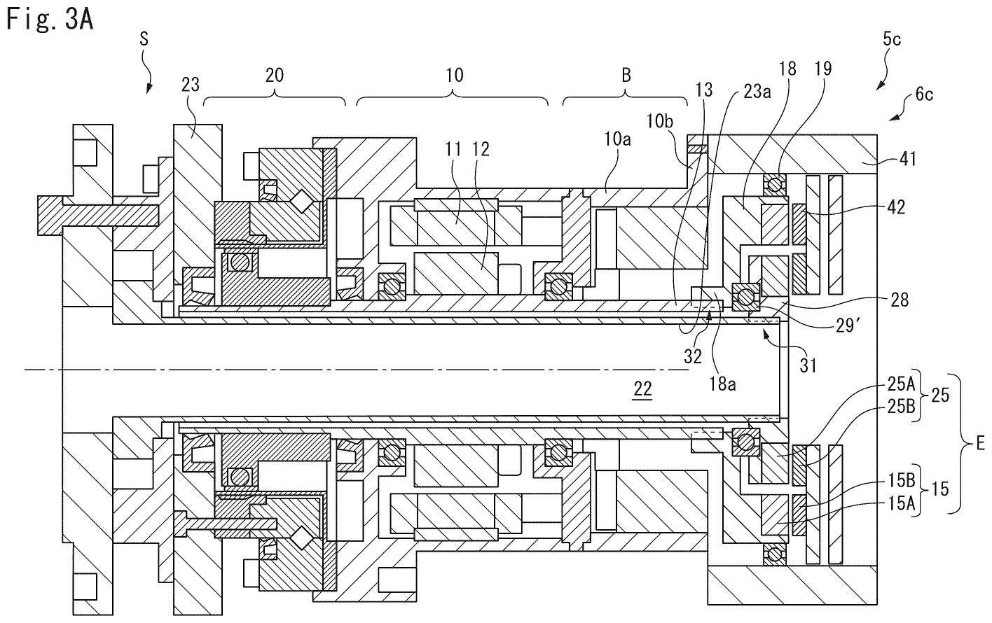

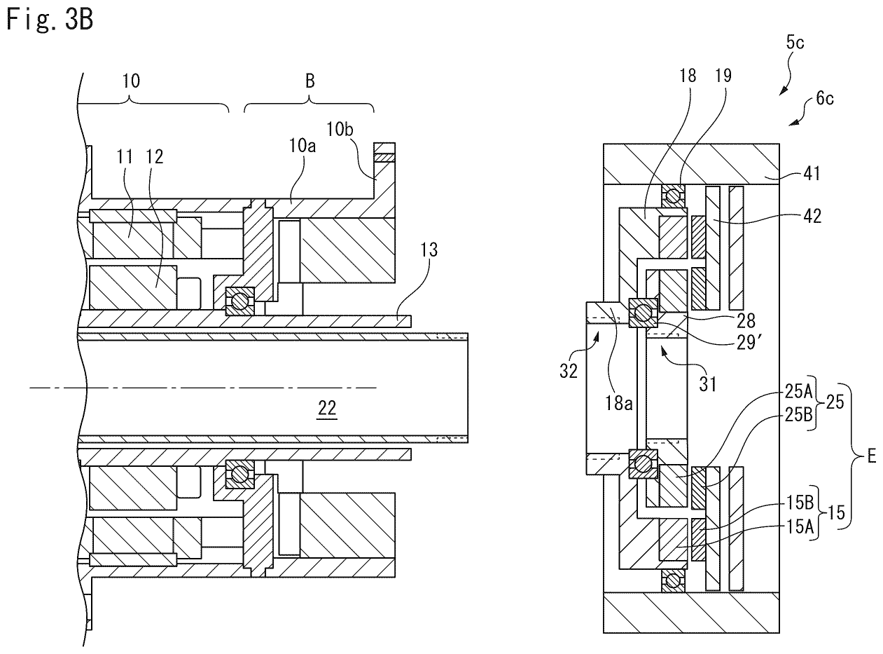

FIG. 3A is an axial cross-sectional view of an actuator according to a third embodiment of the present disclosure. The difference between the third embodiment shown in FIG. 3A and the second embodiment shown in FIG. 2A is that the second support member 28 is connected to the first support member 18 via a bearing 29′, and the extension member 41 does not include a portion extending in the radial direction and is cylindrical.

FIG. 3B is a partial exploded view of the actuator of the third embodiment. As shown in FIG. 3B, the unit 6c as a part of the actuator 5c includes the extension member 41, the bearing 29′, the second support member 28, the substrate 42 including the detector 15B and the detector 25B, the rotating disk 25A, the first support member 18, the rotating disk 15A, and the bearing 19. The unit 6c is configured so as to be capable of operating as an integral unit.

It will be understood that the third embodiment also provides substantially the same effects as the second embodiment. Furthermore, since the second support member 28 is not connected to the extension member 41 in the third embodiment, the extension member 41 need not include a portion extending in the radial direction. As a result, a relatively large space on the rear end side of the actuator 5c can be secured. It will be understood that when a plurality of umbilical members (not illustrated) pass through the hollow portion 22, it becomes easy to umbilical member the plurality of umbilical members on the rear end side of the actuator 5c.

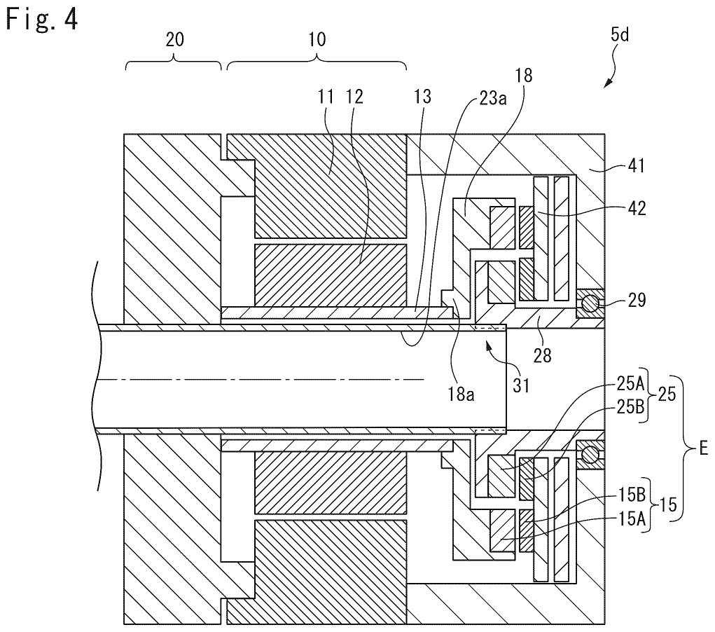

FIG. 4 is an axial cross-sectional view of an actuator according to another embodiment. The actuator 5d shown in FIG. 4 primarily comprises the motor 10 consisting of the stator 11 and the rotor 12, the speed reducer 20 which is connected to the motor 10, and the encoder E. Specifically, the actuator 5d does not include a force sensor S and an electromagnetic brake B. The extension member 41 is attached to the stator 11. It will be understood that in such a case, the actuator 5d can be made even smaller. Further, the case in which the actuators 5a to 5c described above are configured so as to not include the force sensor S and/or the electromagnetic brake B is considered to be within the scope of the present disclosure.

At least one of the embodiments described above has the advantage that the output shaft of the speed reducer and the rotating disk of the secondary encoder are connected to each other by the first joint, which enables space saving.

Though the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

In relation to the embodiments and modification examples described above, the following addendums are further disclosed.

### (Addendum 1)

An actuator (5a to 5d), comprising:

a motor (10),

a speed reducer (20) which is connected to the motor (10),

a primary encoder (15) for detecting a position of a motor shaft (13) of the motor (10), and

a secondary encoder (25) for detecting a position of an output shaft (23) of the speed reducer (20), wherein

a rotating disk (25A) of the secondary encoder (25) is arranged concentrically relative to a rotating disk (15A) of the primary encoder (15), and

the actuator (5a to 5d) further comprising a first joint (31) for connecting the output shaft (23) of the speed reducer (20) and the rotating disk (25A) of the secondary encoder (25) to each other.

### (Addendum 2)

The actuator (5a to 5d) according to Addendum 1, wherein the first joint (31) is configured to slide a portion (6a) of the actuator (5a to 5d) including the rotating disk (25A) of the secondary encoder (25) in the axial direction of the actuator (5a to 5d) so as to connect to the output shaft.

### (Addendum 3)

The actuator (5a to 5d) according to Addendum 1 or 2, wherein the first joint (31) includes splines or an Oldham coupling.

### (Addendum 4)

The actuator (5a to 5d) according to any one of Addenda 1 to 3, further comprising a second joint (32) for connecting the motor shaft (13) of the motor (10) and the rotating disk (15A) of the primary encoder (15) to each other.

### (Addendum 5)

The actuator (5a to 5d) according to Addendum 4, wherein the second joint (32) is configured to slide a portion (6b) of the actuator (5a to 5d) including the rotating disk (15A) of the primary encoder (15) in the axial direction of the actuator (5a to 5d) so as to connect to the motor shaft (13).

### (Addendum 6)

The actuator (5a to 5d) according to Addendum 4 or 5, wherein the second joint (32) includes splines or an Oldham coupling.

### (Addendum 7)

The actuator (5a to 5d) according to any one of Addenda 1 to 6, wherein a bearing (29′) is arranged between the rotating disk (25A) of the secondary encoder (25) and a component including the rotating disk (15A) of the primary encoder (15).

### REFERENCE SIGNS LIST

5a to 5d actuator

6a, 6b unit

10 motor

10a housing

10b flange

11 stator

12 rotor

13 motor shaft

15 primary encoder

15A rotating disk

15B detector

18 first support member

18a protrusion

20 speed reducer

23 output part

23a extension

25A rotating disk

25B detector

28 second support member

19, 29, 29′ bearing

31 first joint

31a first hub

31b second hub

31c insert

32 second joint

41 extension member

42 substrate

B electromagnetic brake

E encoder

S force sensor

What is claimed is:

1. An actuator, comprising:
a motor;
a speed reducer which is connected to the motor;
a primary encoder for detecting a position of a motor shaft of the motor; and
a secondary encoder for detecting a position of an output shaft of the speed reducer, wherein
a rotating disk of the secondary encoder is arranged concentrically relative to a rotating disk of the primary encoder, and
the actuator further comprising a first joint for connecting the output shaft of the speed reducer and the rotating disk of the secondary encoder to each other.

2. The actuator according to claim 1, wherein the first joint is configured to slide a part of the actuator including the rotating disk of the secondary encoder in the axial direction of the actuator so as to connect to the output shaft.

3. The actuator according to claim 2, wherein the first joint includes splines or an Oldham coupling.

4. The actuator according to claim 1, further comprising a second joint for connecting the motor shaft of the motor and the rotating disk of the primary encoder to each other.

5. The actuator according to claim 4, wherein the second joint is configured to slide a part of the actuator including the rotating disk of the primary encoder in the axial direction of the actuator so as to connect to the motor shaft.

6. The actuator according to claim 5, wherein the second joint includes splines or an Oldham coupling.

7. The actuator according to claim 1, wherein a bearing is arranged between the rotating disk of the secondary encoder and a part including the rotating disk of the primary encoder.
